(19) United States
(12) Patent Application Publication
(10) Pub. No.: US 2006/0164049 A1
(43) Pub. Date: Jul. 27, 2006

(54) Method of power supply to low-voltage power consumers

(76) Inventor: Thomas Duerbaum, Langerwehe (DE)

Correspondence Address: PHILIPS INTELLECTUAL PROPERTY & STANDARDS, P.O. BOX 3001, BRIARCLIFF MANOR, NY, 10510, US

(21) Appl. No.: 10/319,892

(22) Filed: Dec. 13, 2002

(30) Foreign Application Priority Data
Dec. 19, 2001 (DE) 10162274.0

(51) Int. Cl. G05F 1/40; G05F 1/618

(52) U.S. Cl. 323/271

(57) ABSTRACT

The invention relates to a method of regulating the power supply to at least one power consumer which is connected via a voltage regulator (2) to a voltage output of a DC voltage source (1) at which a supply voltage (U₀) is present. To minimize power losses, it is proposed that

(a) a regulation signal is generated for the voltage regulator (2) which regulation signal depends on at least one input voltage (Uᵢₙ) present at the voltage regulator (2) and on a reference value (V_{ref}) which is specific of the voltage regulator (2), and

(b) the supply voltage (U₀) of the DC voltage source (1) is regulated in dependence on the regulation signal.

The invention relates to a method of regulating the power supply to at least one power consumer which is connected via a voltage regulator to a voltage output of a DC voltage source at which a supply voltage is present. The invention also relates to a circuit arrangement for regulating the power supply to at least one power consumer with a DC voltage source at which a supply voltage is present and at least one voltage regulator which has at least one voltage output which is connected to the power consumer.

In the structure of logical circuit arrangements, digital modules having a low supply voltage so-called low-voltage level devices such as, for example, μC and DSP are often used. Analog modules are also used depending on the field of application. Both the digital and the analog modules need to have a well-adjusted supply voltage.

Power packs are used for the power supply, which power packs take over, for example, the task of separating the logical circuit arrangement from the network and transforming the mains voltage to a low voltage. The modules and the power pack are often arranged on separate pc boards because the power pack can be arranged on a unilayer pc board, whereas the logical modules are disposed on a multilayer pc board the so-called application board.

A problem with the reliable voltage supply of the modules consists of the fact that they need low supply voltages for which it is to be expected that the supply voltage of modules to be developed in the future will be lower. It is also to be expected for the current consumption of such modules to increase. Based on the high current consumption the supply voltage rendered available by the power pack will drop in the lines from the power pack to the module and also at the plug contacts of the modules. As a result a readjustment of the supply voltage is necessary.

This readjustment is made at the module itself by a voltage regulator, particularly by a linear regulator. It needs to have a minimum voltage drop between its input and output voltage in order to have a flawless operation, which voltage drop is to be maintained under all circumstances. Therefore, the linear regulator is to be supplied on the input side with sufficient voltage reserve so that the linear regulator operates flawlessly under any load conditions and other effects such as, for example, the ageing of transition contacts as a result of which the input voltage may drop. A considerable disadvantage is then that the voltage drop in the linear regulator, combined with the high currents leads to high losses which are dissipated as heat. Sometimes even heat sinks are necessary for the dissipation.

To minimize these losses, there is endeavored to supply an input voltage to the linear regulator so that the voltage reserve is reduced to a minimum value.

From U.S. Pat. No. 6,031,362 is known a method of the type defined in the opening paragraph in which a power pack supplies power to one or various power consumers via a voltage output. The voltage necessary for the power consumers is regulated by a linear regulator at the power consumer end while preferably low-drop-out-linear regulators (LDO) are used which, compared with other linear regulators, offer the advantage that they need a comparatively small minimum voltage drop. To be able to render sufficiently high input voltages available to the linear regulators, the supply voltage present on the output of the power pack is regulated in that the output voltages of all the linear regulators are detected at regular intervals, digitized and applied to a processor unit. The processor unit generates from all the measured values a regulation signal for regulating the power pack. The regulation is then arranged so that the supply voltage of the power pack is so high that a regulator leaves its regulation range and no longer regulates its output voltage to the desired value.

A disadvantage in this known voltage regulator is that a too small voltage reserve at one or more linear regulators is not detected until it is too small and the output voltage on the linear regulator has therefore dropped already. Furthermore, there is a disadvantage that a voltage drop at the output of the linear regulator may be the result of a change of its operating temperature. This voltage drop cannot be compensated for by an increase of the voltage reserve. Thus for the regulation there is to be taken into account whether a drop of the output voltage at the linear regulator is inherent in the regulator or is determined by a too small voltage reserve. Whether the voltage reserve in such a case is too small is detected in that the input voltage at the linear regulator is briefly increased. If no increase of the output voltage is detected afterwards, the voltage reserve is sufficient and the input voltage can again be lowered to the previous value. If the output voltage, however, increases, the supply voltages at the output of the power pack are to be increased until no increase of the output voltage of the respective linear regulator can be detected anymore. This type of control is costly and is accompanied with losses.

It is therefore an object of the present invention to provide a method of the type defined in the opening paragraph in which the power losses mentioned above are minimized.

This object is achieved by a method of the type defined in the opening paragraph in that

(a) a regulation signal is generated which is dependent at least on an input voltage present at the voltage regulator and a reference value specific of the voltage regulator, and

(b) the supply voltage of the DC voltage source is regulated in dependence on the regulation signal.

In a circuit arrangement of the type defined in the opening paragraph this object is achieved by at least one driver circuit whose signal output is connected to a regulation signal input of the DC voltage source and at whose signal output a regulation signal is present which is generated at least in dependence on an input voltage present at the voltage regulator and a reference value specific of the voltage regulator.

In that which follows, a DC voltage source is understood to be any voltage source that is suitable for rendering a DC voltage available. This may be, for example, a power pack or a converter, while the DC voltage source itself can be supplied with a DC voltage or an AC voltage.

In that which follows, power consumers are understood to be a single circuit element or a single logical module, but also an arrangement of a plurality of circuit elements and/or logical modules, particularly on an application board. Also modules and assemblies may be referred to then.

According to the invention it is provided that the supply voltage on the output of the DC voltage source is regulated by a regulation signal which is generated in dependence on the input voltage present on the input of the voltage regulator and on a reference value specific of the voltage regulator—more particularly the reference value of a driver circuit. If the input voltage at the voltage regulator is too low, the supply voltage at the output of the DC voltage source is increased.

Based on the voltage regulation in the DC voltage source in dependence on the input voltages present at the voltage regulator, it is possible to minimize the reserve necessary for a certain operating state of the circuit to the height of the voltages rendered available by the DC voltage source and still guarantee a constant supply voltage for the individual power consumers. Since a control of the supply voltage of the DC voltage source is dependent on the input voltage of the voltage regulator, it may be prevented that the minimum voltage reserve is reached or surpassed before the output voltage at the voltage regulator drops as a result of a too low input voltage. Thus a reliable power supply to the power consumers can be guaranteed and unnecessary power losses may be avoided. Since less heat dissipation arises in this manner, the requirements for the constructive measures for heat dissipation are less strict. This also provides advantages with respect to the reliability of the individual module and circuit elements.

A minimum set value for the input voltage needed is preferably used as a reference value and the regulation signal is determined from a function of the difference between the actual value of the locally applied input voltage and the minimum set value of the input voltage. The minimum input voltage value then depends on the type of voltage regulator and on the level of the output voltage to be stabilized.

Also in another preferred embodiment of the method can be used a minimum set value as a reference value for the difference between input and output voltage at this voltage regulator, thus a value for the minimum voltage drop necessary for the operation of the voltage regulator, and the regulation signal can be determined from a function of this minimum set value and the actual value of the voltage drop occurring at the voltage regulator.

A preferred possibility of generating the regulation signal consists in the use of an operational amplifier as an error amplifier, at which the analog signals for the actual value of the operating point of the voltage regulator as well as the signal for the associated reference value are present. According to the regulation characteristic the difference of the applied signals from a regulation signal is increased, which regulation signal can be tapped from the output of the operational amplifier and be applied to the DC voltage source.

Another preferred possibility of generating the regulation signal consists in the use of a hysteresis regulator, more particularly a Schmitt trigger at which the analog signals for the actual value of the operating point of the voltage regulator as well as the signal for the respective reference value are present. In such a hysteresis regulator the regulation signal is upconverted when a lower limit of the difference between the actual signal for the operating point of a voltage regulator and the associated reference value is reached, and downconverted again when an upper limit of this difference is reached. In this way the input voltage which is critical for the respective voltage regulator can be kept within a window.

There is also an advantageous possibility of generating the regulation signal in that all the signals having the actual value for the operating point of the voltage regulator, for example, its input voltage, are captured digitally via an A/D conversion, and the regulation signal is generated from this or these, respectively, digital signal or signals and a digital reference value. Preferably a digital regulation signal can be generated therefrom, which regulation signal, however, can also be reconverted into an analog regulation signal.

As a voltage regulator may preferably be used a linear voltage regulator, more particularly, a low-drop-output-linear regulator, but also a switching regulator.

In a further preferred embodiment of the method, a power pack, more particularly a primary clocked switched-mode power pack, is used as a DC voltage source. Particularly AC/DC converters and DC/DC converters are considered as switched-mode power packs, whose power consumption on the primary side of the converter can be regulated. Depending on the type of the DC voltage source the supply voltage may also be regulated at its output, for example, by clocking the power supply at a capacitor provided at the output of the DC voltage source.

In the method according to the invention a DC voltage supply may also be used having a plurality of voltage outputs to which a respective one or plurality of power consumers are connected via a voltage regulator and in which the supply voltage of each voltage output is regulated via a regulation signal generated for a corresponding voltage regulator.

In the following the invention will be further explained with reference to a drawing Figure which shows a preferred circuit arrangement for the method to be implemented.

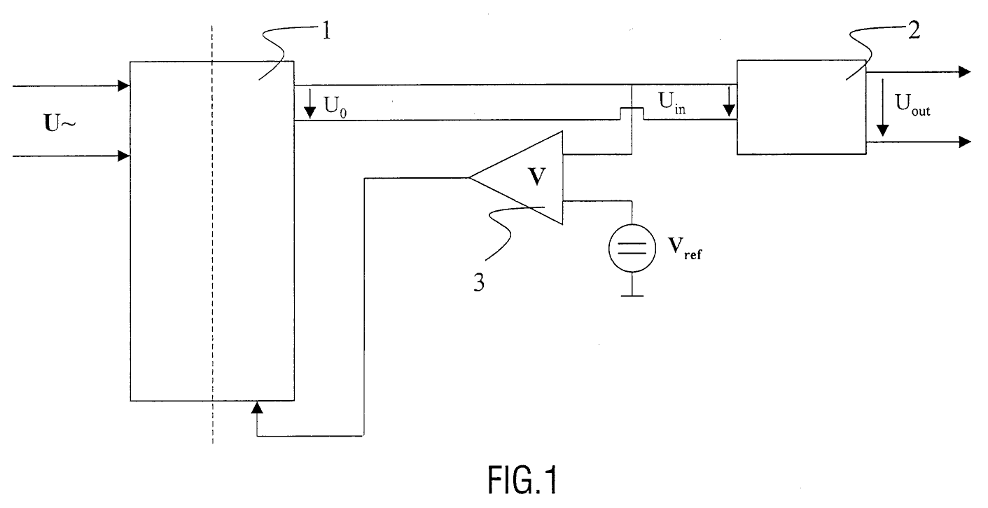

The circuit diagram shown in FIG. 1 shows as a voltage source a main power pack 1 whose input is connected to an AC voltage network and which has a voltage output at which the supply voltage U₀ is present.

The voltage output of the main power pack 1 is connected to the input of a voltage regulator 2 and supplies an input voltage Uᵢₙ thereto. The supply voltage U₀ and the input voltage Uᵢₙ in the voltage regulator 2 are customarily different as a result of line losses. The voltage regulator 2 is connected on its output side to a power consumer not shown here and supplies a regulated output voltage Uₒᵤₜ thereto.

An actual value for its operating point is tapped from the voltage regulator 2. This actual value may be, for example as represented, the input voltage Uᵢₙ but also the difference value between the input voltage Uᵢₙ and the output voltage Uₒᵤₜ as a measure for the existing voltage reserve.

Difference values between the actual value assigned to the voltage regulator 2, here the input voltage Uᵢₙ, and a reference value V_{ref} for the voltage regulator 2 are formed in a driver circuit 3 and the regulation signal is then generated from these difference values. The reference value may be, for example, a value for the minimum voltage drop which is necessary to guarantee sufficient voltage reserve for the voltage regulator 2.

The actual values for the operating point of the voltage regulator 2 may be processed either in analog form, depending on the arrangement of the driver circuit, or they are digitized, so that the evaluation as well as the generation of regulation signals can be effected in digital form.

In the example shown the driver circuit 3 is arranged as an analog circuit comprising an error or operational amplifier 3 at whose input the input voltage Uᵢₙ present at the voltage regulator 2 as well as an associated reference value V_{ref} are present. The operational amplifier produces a positive output signal as a regulation signal when the respective reference value is slightly fallen short of, which regulation signal is applied to the main power pack for controlling the supply voltage U₀.

1. A method of regulating the power supply to at least one power consumer which is connected via a voltage regulator (2) to a voltage output of a DC voltage source (1) at which a supply voltage (U₀) is present, characterized in that
(a) a regulation signal is generated which is dependent on an input voltage (Uᵢₙ) present at the voltage regulator (2) and a reference value (V_{ref}) specific of the voltage regulator (2), and
(b) the supply voltage (U₀) of the DC voltage source (1) is regulated in dependence on the regulation signal.

2. A method as claimed in claim 1, characterized in that the reference value (V_{ref}) is a minimum set value for the necessary input voltage of the voltage regulator (2) and the regulation signal is determined from a function of the difference between the actual value of the input voltage (Uᵢₙ) present at the voltage regulator (2) and a minimum control value of the input voltage of the voltage regulator (2).

3. A method as claimed in claim 1, characterized in that the reference value (V_{ref}) is a minimum regulation value for the difference between input and output voltage of the voltage regulator (2) and the regulation signal is determined from a function of the minimum control value and the actual value of the difference which is found between the input voltage (Uᵢₙ) present on the voltage regulator (2) and the output voltage (Uₒᵤₜ).

4. A regulation method as claimed in one of the claims 1 to 3, characterized in that an error amplifier is used for generating the regulation signal.

5. A regulation method as claimed in one of the claims 1 to 3, characterized in that an hysteresis regulator, more particularly a Schmitt trigger, is used for generating the regulation signal.

6. A regulation method as claimed in one of the claims 1 to 3, characterized in that at least the input voltage (Uᵢₙ) present at the voltage regulator (2) is detected digitally and the processing of the regulation signal is effected at least in dependence on the digitized input voltage (Uᵢₙ) and a digital reference value (V_{ref}).

7. A regulation method as claimed in one of the claims 1 to 6, characterized in that the regulation signal is evaluated in digital form.

8. A regulation method as claimed in one of the claims 1 to 7, characterized in that a linear regulator, more particularly a low-drop-output-linear regulator is used as a voltage regulator (2).

9. A regulation method as claimed in one of the claims 1 to 8, characterized in that a power pack, more particularly a primary clocked switched-mode power pack, is used as a DC voltage source (1).

10. A regulation method as claimed in one of the claims 1 to 9, characterized in that the DC voltage source (1) has a plurality of voltage outputs to which one or more respective power consumers are connected via a respective voltage regulator (2₁, 2₂, . . . 2ₙ) and where the supply voltage (U₀₁, U₀₂, . . . , U₀ₙ) of each voltage output is regulated via a regulation signal generated for a corresponding voltage regulator (2₁, 2₂, . . . , 2ₙ).

11. A circuit arrangement for regulating the power supply to at least one power consumer comprising a DC voltage source (1) at which a supply voltage (U₀) is present, and at least one voltage regulator (2) having at least one voltage output which is connected to the power consumer, characterized by at least one driver circuit (3) whose signal output is connected to a regulation signal input of the DC voltage source (1) and at whose signal output a regulation signal is present which is generated at least in dependence on an input voltage (Uᵢₙ) present at the voltage regulator (2) and in dependence on a reference value (V_{ref}) specific of the voltage regulator (2).
